(19) United States
(12) Patent Application Publication
(10) Pub. No.: US 2015/0195174 A1
(43) Pub. Date: Jul. 9, 2015

(54) TRAFFIC DATA COLLECTION APPARATUS, TRAFFIC DATA COLLECTION METHOD AND PROGRAM

(71) Applicant: NEC CORPORATION, Tokyo (JP)

(72) Inventor: Masayo Kogami, Tokyo (JP)

(21) Appl. No.: 14/419,007

(22) PCT Filed: Jul. 10, 2013
(86) PCT No.: PCT/JP2013/068847

§ 371 Date: Feb. 2, 2015

(30) Foreign Application Priority Data
Aug. 2, 2012 (JP) 2012-172381

(51) Int. Cl. H04L 12/26

(52) U.S. Cl. CPC H04L 43/0876; H04L 43/50

(57) ABSTRACT

A traffic data collection apparatus includes a generating unit configured to generate traffic data that is information on traffic processed by a device under management, a computation unit configured to calculate the amount of computational resources spent by the generating unit to generate traffic data during a predetermined collection granularity period, and a determination unit configured to determine that traffic data is excessive when the amount of computational resources calculated by the computation unit exceeds a predetermined threshold.

### TECHNICAL FIELD

The present invention relates to a traffic data collection apparatus, a traffic data collection method, and a program for managing traffic data in a network system.

### BACKGROUND ART

Traffic data, which is information on traffic processed by individual nodes, is used to determine whether additional nodes that make up a network system need to be installed and to determine the status of each node for maintenance and management of the network system.

Examples of elements that constitute traffic data include data indicating a failure in wireless resource acquisition or resource busy, a call connection failure factor, and a handoff failure factor.

PTL 1 discloses a technique for collecting traffic data and determining the allowable range in which the volume of traffic is processed in accordance with the traffic data.

PTL 2 and PTL 3 also disclose techniques for analyzing traffic data and determining occurrence of a failure in accordance with the traffic data.

### CITATION LIST

### Patent Literature

[PTL 1] Japanese Patent Application Publication No. 2007-259368

[PTL 2] Japanese Patent Application Publication No. 2001-036484

[PTL 3] Japanese Patent Application Publication No. 2000-253148

### SUMMARY OF INVENTION

### Technical Problem

As the wireless communication technology is advancing, the number of functions of each node in network systems is increasing. The increased number of node functions leads to an increase in categories of elements that constitute traffic data to be used for determining the status, for example. An excess of categories of elements that constitute traffic data makes it difficult for an apparatus for collecting traffic data to collect all traffic data within a granularity period of traffic data.

The techniques disclosed in PTL 1 to PTL 3 can be used to determine the status of processing traffic, but cannot be used to determine whether there is any problem with collecting traffic data.

The present invention aims to provide a traffic data collection apparatus, a traffic data collection method, and a program that solve the above problem.

### Solution to Problem

To solve the above problem, the present invention provides a traffic data collection apparatus that includes a generating unit configured to generate traffic data that is information on traffic processed by a device under management, a computation unit configured to calculate the amount of computational resources spent by the generating unit to generate traffic data during a predetermined granularity period, and a determination unit configured to determine that traffic data is excessive when the amount of computational resources calculated by the computation unit exceeds a predetermined threshold.

As a typical example, the traffic data collection apparatus includes a setting storage unit configured to store categories of elements that constitute the traffic data and a deletion unit configured to delete one or more categories stored in the setting storage unit when the determination unit determines that traffic data is excessive. The generating unit generates, out of information on traffic processed by the device under management, traffic data consisting of elements the categories of which are stored in the setting storage unit.

The deletion unit may be configured to receive, from an administrator, input of a category that needs to be omitted from the traffic data and delete the category from the setting storage unit.

As a preferred example, the setting storage unit stores priorities in association with the respective categories, and the deletion unit deletes a category of the lowest priority of the categories stored in the setting storage unit when the determination unit determines that traffic data is excessive.

As another preferred example, the traffic data collection apparatus includes a warning unit configured to issue a warning when the determination unit determines that traffic data is excessive.

As still another preferred example, the computation unit calculates the volume of the traffic data generated by the generating unit during a predetermined granularity period as the amount of the computational resources.

An aspect of the present invention provides a traffic data collection method that includes the steps of generating traffic data that is information on traffic processed by a device under management, recording the generated traffic data in a data storage unit, calculating the volume of traffic data stored in the data storage unit, and determining that traffic data is excessive when the calculated volume of data exceeds a predetermined threshold.

As a typical example, the generation step generates, out of information on traffic processed by the device under management, traffic data consisting of elements the categories of which are stored in the setting storage unit configured to store categories of elements that constitute traffic data. A deletion step is included that deletes one or more categories stored in the setting storage unit when the determination step determines that traffic data is excessive.

An aspect of the present invention also provides a computer program that causes a computer to serve as a generating unit configured to generate traffic data that is information on traffic processed by a device under management, a recording unit configured to record the traffic data generated by the generating unit in a data storage unit, a computation unit configured to calculate the volume of traffic data stored in the data storage unit, and a determination unit configured to determine that traffic data is excessive when the volume of data calculated by the computation unit exceeds a predetermined threshold.

As a typical example, the computer is caused to serve as a deletion unit configured to delete one or more categories stored in a setting storage unit configured to store categories of elements that constitute the traffic data when the determination unit determines that traffic data is excessive. The generating unit generates, out of information on traffic processed by the device under management, traffic data consisting of elements the categories of which are stored in the setting storage unit.

### Advantageous Effects of Invention

The present invention enables determination, as to whether traffic data is excessive, in accordance with the volume of the traffic data.

### BRIEF DESCRIPTION OF DRAWINGS

FIG. 1 is a schematic diagram showing a configuration of an LTE system according to a first embodiment of the present invention.

FIG. 2A is a diagram showing an example of a setting screen according to the first embodiment.

FIG. 2B is a diagram similarly showing an example of the setting screen.

FIG. 2C is a diagram similarly showing an example of the setting screen.

FIG. 3 is a flowchart showing operation of a maintenance server according to the first embodiment.

FIG. 4 is a schematic diagram showing a configuration of an LTE system according to a second embodiment of the present invention.

FIG. 5A is a diagram showing an example of a setting screen according to the second embodiment.

FIG. 5B is a diagram similarly showing an example of the setting screen.

FIG. 5C is a diagram similarly showing an example of the setting screen.

FIG. 6 is a schematic block diagram showing a basic configuration of a traffic data collection apparatus according to an embodiment of the present invention.

### DESCRIPTION OF EMBODIMENTS

### First Embodiment

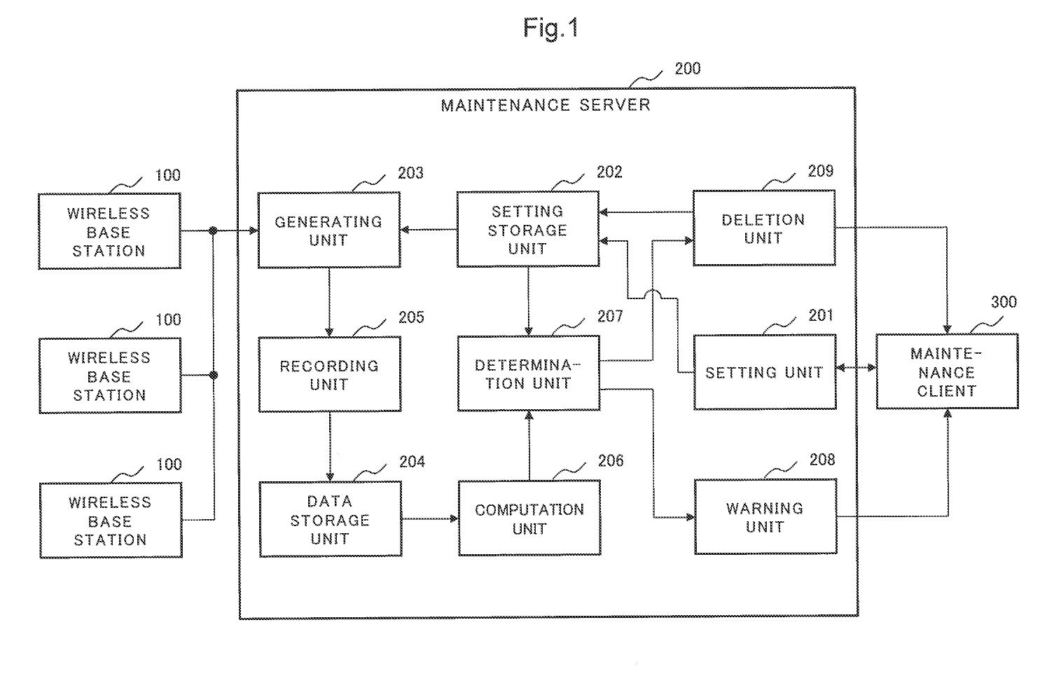

The following describes embodiments of the present invention with reference to the drawings. FIG. 1 is a schematic diagram showing a configuration of an LTE (Long-Term Evolution) system according to a first embodiment of the present invention.

The LTE system includes:
a plurality of wireless base stations 100 (eNodeB);
a maintenance server 200 (an element management system-server (EMS-S) that serves as a traffic data collection apparatus); and
a maintenance client 300 (an element management system-client (EMS-C)).

The wireless base stations 100 conduct wireless communications with communication terminals.

The maintenance server 200 manages the wireless base stations 100.

The maintenance client 300 inputs and outputs data to and from the maintenance server 200.

The maintenance server 200 includes a setting unit 201, a setting storage unit 202, a generating unit 203, a data storage unit 204, a recording unit 205, a computation unit 206, a determination unit 207, a warning unit 208, and a deletion unit 209.

The setting unit 201 receives, from the maintenance client 300, input of categories of elements required to analyze traffic data, a first and a second thresholds to determine whether traffic data is excessive, and a granularity period (GP) for collecting traffic data, and records such information in the setting storage unit 202.

This operation allows the setting storage unit 202 to store categories of elements that constitute (i.e., that are required to analyze) traffic data, the first and the second thresholds, and a collection GP.

The generating unit 203 generates, for each traffic processed by a device under management (wireless base station 100, for example), traffic data that is information on the traffic in accordance with information stored in the setting storage unit 202.

The data storage unit 204 stores the traffic data generated by the generating unit 203.

The recording unit 205 records the traffic data generated by the generating unit 203 in the data storage unit 204.

The computation unit 206 calculates the total of traffic data volumes (calculated as file sizes) stored in the data storage unit 204.

The determination unit 207 determines whether traffic data is excessive, by comparing the volume of data calculated by the computation unit 206 with predetermined first and second thresholds. Note that the first threshold value is less than the second threshold value.

The warning unit 208 sends a warning message to the maintenance client 300 when the determination unit 207 determines that the volume of data exceeds the first threshold.

The deletion unit 209 deletes one or more categories of elements that constitute the traffic data stored in the setting storage unit 202 in accordance with an operation of the maintenance client 300 when the determination unit 207 determines that the volume of data exceeds the second threshold.

The operation of the maintenance server 200 is now described.

First, the operation to be performed to record setting information in the setting storage unit 202 of the maintenance server 200 is described.

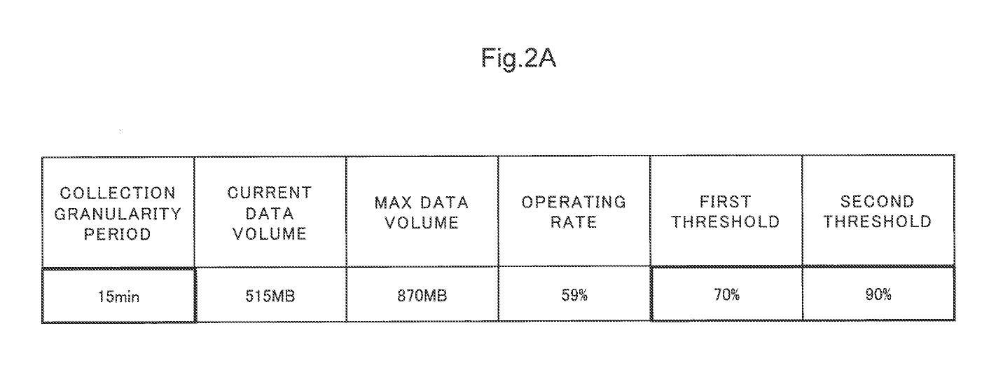

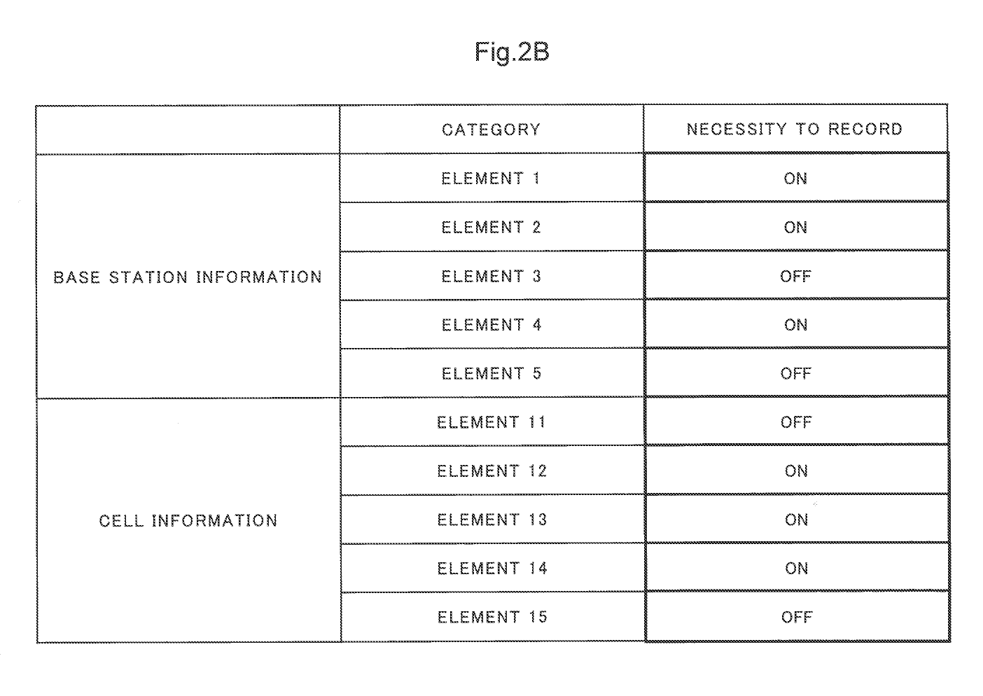

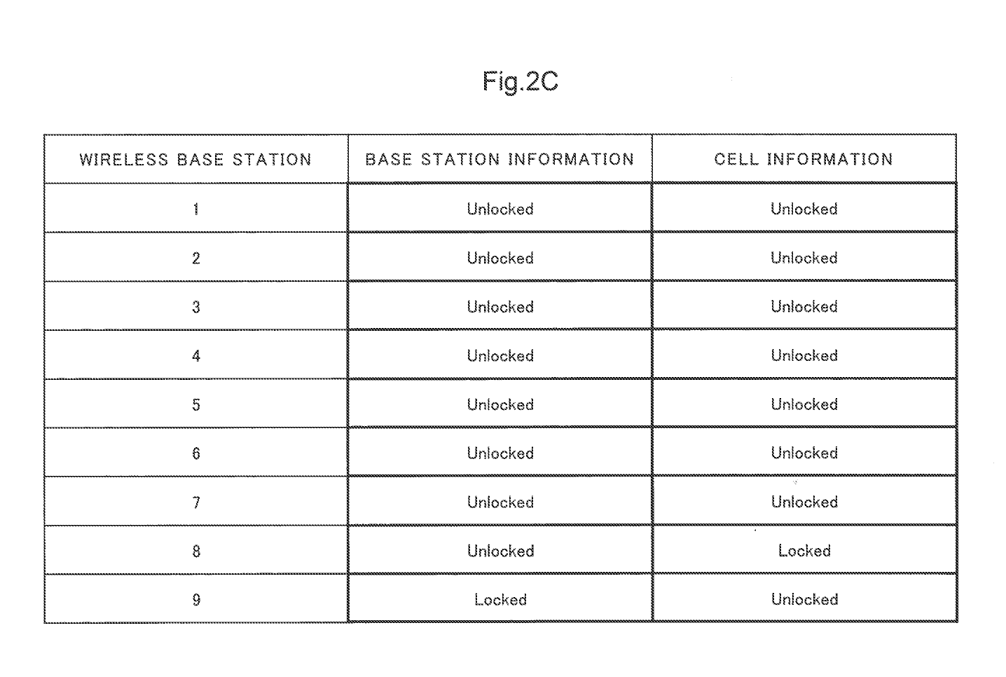

When an administrator causes the maintenance client 300 to send a request for change of setting information to the maintenance server 200, the setting unit 201 of the maintenance server 200 causes the maintenance client 300 to display a setting screen that includes the details shown in FIGS. 2A to 2C.

FIGS. 2A to 2C are diagrams showing display examples of the setting screen according to the first embodiment of the present invention. The portions surrounded by thick frames in FIGS. 2A to 2C are rewritable information.

On the setting screen, information stored in the setting storage unit 202 of the maintenance server 200 is displayed.

Of the information, the maintenance client 300 can rewrite the collection GP, the first threshold, and the second threshold shown in FIG. 2A, necessity to record each element of traffic data shown in FIG. 2B, and the base station information and the cell information in FIG. 2C to be described below.

The max data volume shown in FIG. 2A is a maximum volume of data the processing of which can be completed within the collection GP with the capacity of the apparatus.

The operating rate in FIG. 2A indicates the percentage of the current data volume in the max data volume.

As shown in FIG. 2B, elements of traffic data can be broken down into elements included in base station information acquired from the individual wireless base stations 100 and elements included in cell information acquired from cells reporting to the corresponding wireless base stations 100. As shown in FIG. 2C, whether to acquire base station information and cell information or not can be set (as Unlocked or Locked) for each base station 100.

When the maintenance client 300 rewrites the information displayed on the setting screen, the setting unit 201 of the maintenance server 200 rewrites information in the setting storage unit 202 in accordance with the information acquired from the maintenance client 300.

Next, the operation to be performed when the maintenance server 200 collects traffic data is described.

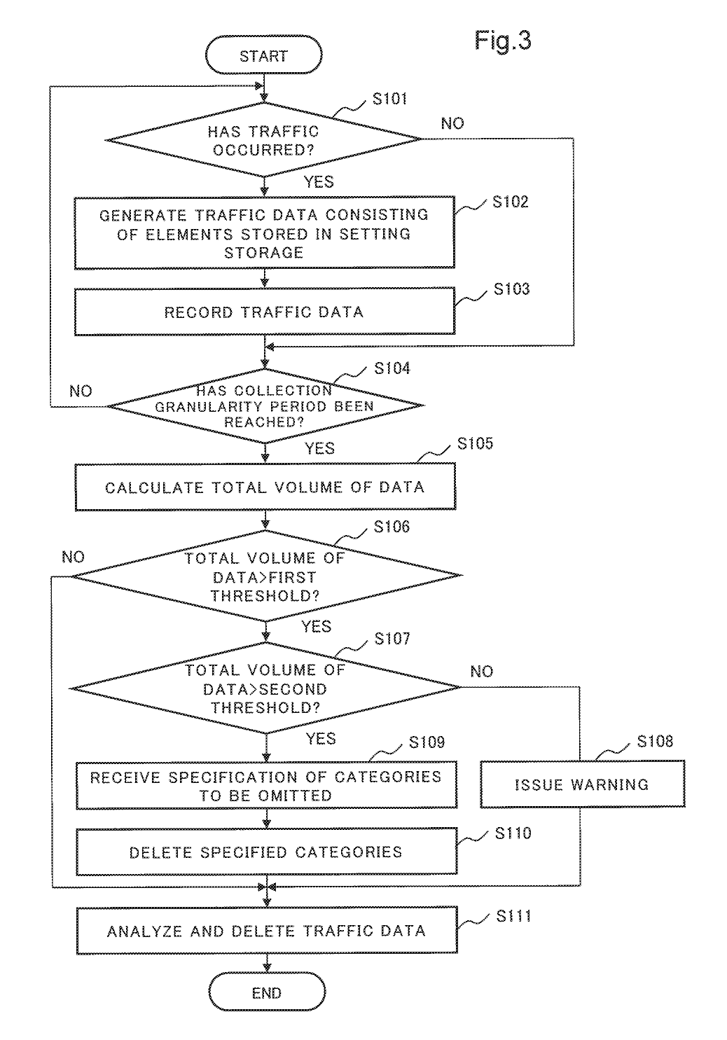

FIG. 3 is a flowchart showing operation of the maintenance server 200 according to the first embodiment of the present invention.

When the maintenance server 200 is brought into operation, the generating unit 203 monitors traffic on the communication network of the wireless base stations 100 to determine whether traffic has occurred (Step S101).

When the generating unit 203 determines that traffic has occurred (Step S101: YES), the generating unit 203 extracts elements of categories stored in the setting storage unit 202 for the traffic and generates traffic data (Step S102).

The recording unit 205 then records the traffic data generated by the generating unit 203 in the data storage unit 204 (Step S103).

When the generating unit 203 determines that no traffic has occurred at Step S101 (Step S101: NO), or when the recording unit 205 records the traffic data at Step S103, the determination unit 207 determines whether a time elapsed since the operation started has reached the collection GP stored in the setting storage unit 202 (Step S104).

When the determination unit 207 determines that the elapsed time has not reached the collection GP (Step S104: NO), the maintenance server 200 returns to Step S101 and continues to monitor traffic as described above.

When the determination unit 207 determines that the elapsed time has reached the collection GP (Step S104: YES), the computation unit 206 calculates the total volume of the traffic data stored in the data storage unit 204 (Step S105).

The determination unit 207 then determines whether the total volume of the data calculated by the computation unit 206 has reached the volume of data the first threshold stored in the setting storage unit 202 represents (Step S106). The determination unit 207 thus determines whether the traffic data is excessive.

When the determination unit 207 determines that the total volume of the data has reached the first threshold (Step S106: YES), the determination unit 207 determines whether the total volume of the data calculated by the computation unit 206 has reached the volume of data the second threshold stored in the setting storage unit 202 represents (Step S107). The determination unit 207 thus determines what to be processed for the maintenance client 300.

When the determination unit 207 determines that the total volume of the data has not reached the second threshold (Step S107: NO), the warning unit 208 outputs an alarm display that gives warning to the maintenance client 300 (Step S108).

On the other hand, when the determination unit 207 determines that the total volume of the data has reached the second threshold (Step S107: YES), the deletion unit 209 outputs a list of categories stored in the setting storage unit 202 to the maintenance client 300 and receives specification of categories to be omitted from the traffic data (Step S109).

When the administrator specifies one or more categories by operating the maintenance client 300, the deletion unit 209 deletes the specified category or categories from the setting storage unit 202 (Step S110). The elements that constitute the traffic data corresponding to the specified category or categories are thus omitted.

When the determination unit 207 determines that the total volume of the data has not exceeded the first threshold at Step S106 (Step S106: NO), when the warning unit 208 issues a warning at Step S108, or, when the deletion unit 209 deletes the specified category or categories at Step S110, the maintenance server 200 analyzes traffic data stored in the data storage unit 204 and deletes the corresponding traffic data from the data storage unit 204 (Step S111).

As described above, the present embodiment enables the traffic data collection apparatus to determine whether traffic data is excessive, in accordance with the volume of the traffic data.

On the basis of the determination result, a warning can be issued to the administrator and elements that constitute the traffic data can be deleted in order to prevent a failure to collect all the traffic data within a GP for collecting traffic data.

### Second Embodiment

A second embodiment of the present invention is described below.

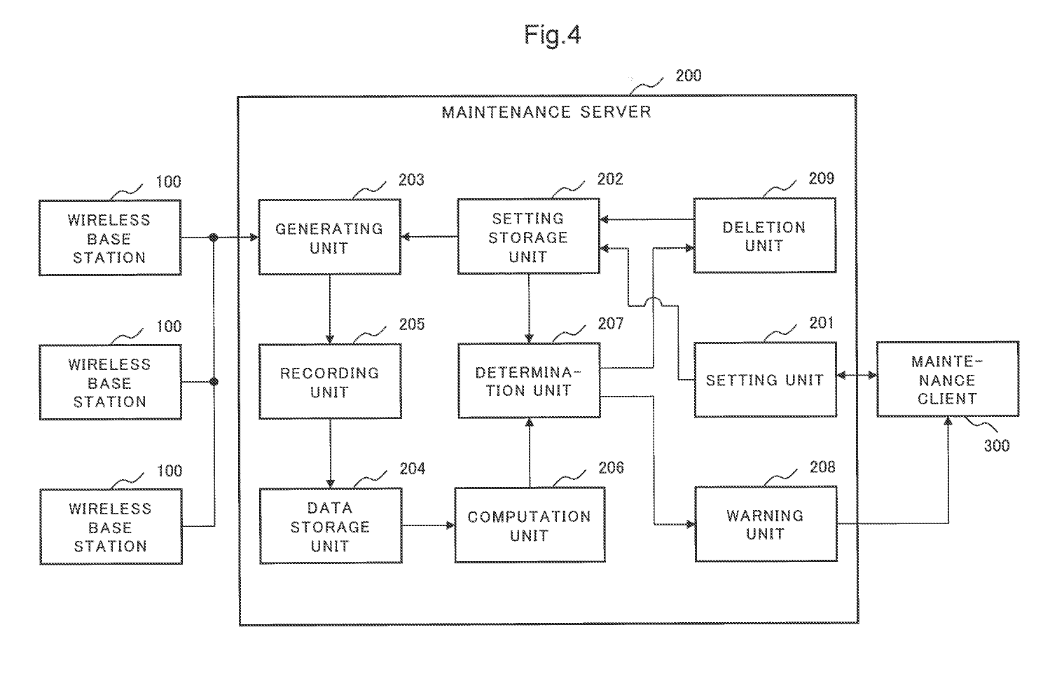

FIG. 4 is a schematic diagram showing a configuration of an LTE system according to the second embodiment of the present invention.

The LTE system according to the second embodiment differs from the LTE system of the first embodiment in information stored in the setting storage unit 202 and the operation of the deletion unit 209.

The setting storage unit 202 stores categories of elements that constitute traffic data, the first and the second thresholds, and a collection GP. The setting storage unit 202 also stores priorities of the categories in association with the corresponding categories of elements. The operation to be performed to record setting information in the setting storage unit 202 is now described.

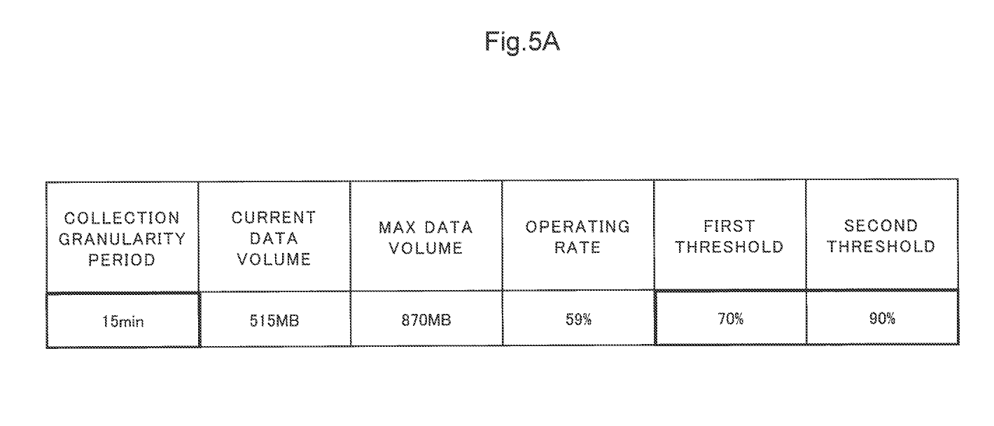

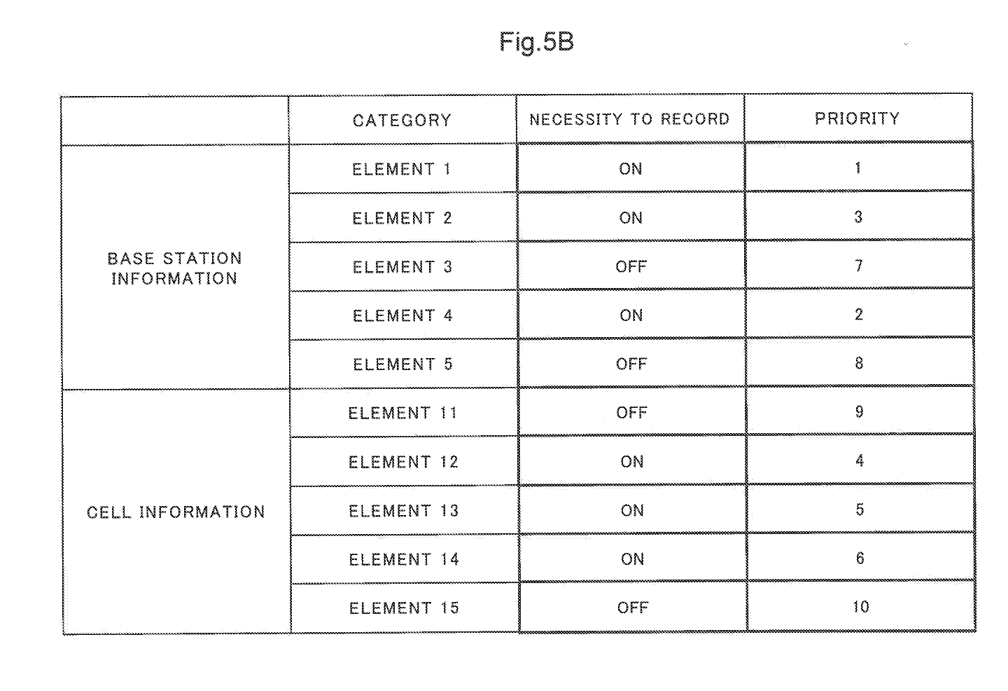

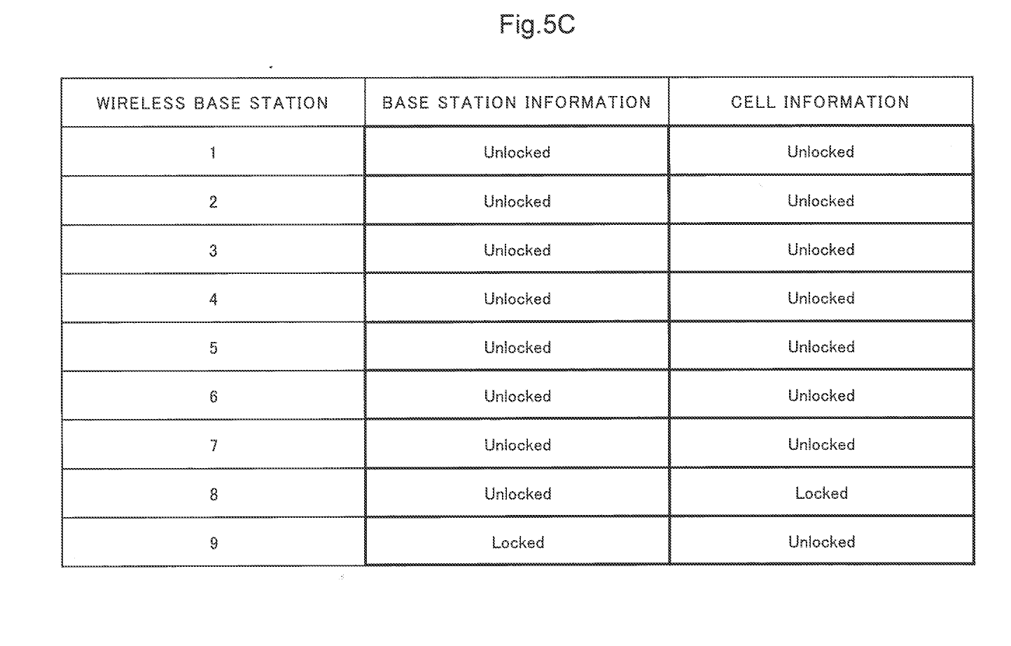

FIGS. 5A to 5C are diagrams showing examples of a setting screen according to the second embodiment of the present invention. The portions surrounded by thick frames in FIGS. 5A to 5C are rewritable information.

On the setting screen, information stored in the setting storage unit 202 of the maintenance server 200 is displayed.

Of the information, the maintenance client 300 can rewrite the collection GP, the first threshold, and the second threshold shown in FIG. 5A, necessity to record each element of traffic data and the priority shown in FIG. 5B, and the base station information and the cell information in FIG. 5C.

When the maintenance client 300 rewrites the information displayed on the setting screen, the setting unit 201 of the maintenance server 200 rewrites information in the setting storage unit 202 in accordance with the information acquired from the maintenance client 300.

The deletion unit 209 of the present embodiment deletes a category of the lowest priority of the categories stored in the setting storage unit 202 when the determination unit 207 determines that the volume of data exceeds the second threshold. This operation enables traffic data to be limited without the administrator's inputting categories to be deleted when the volume of traffic data is excessive.

### Third Embodiment

A third embodiment of the present invention is described below.

The computation unit 206 according to the third embodiment calculates the central processing unit (CPU) usage ratio of the maintenance server 200 (with respect to the processing when the generating unit 203 generates traffic data) and/or a time spent to collect traffic data, in contrast to the computation unit 206 according to the first and the second embodiments that is described for the case of calculating the total volume of traffic data.

The setting storage unit 202 stores thresholds for the CPU usage ratio and the time spent for collection as the first and the second thresholds.

The warning unit 208 issues a warning to the maintenance client 300 when the CPU usage ratio or the time spent to collect traffic data exceeds the first threshold.

The deletion unit 209 deletes one or more categories of elements that constitute the traffic data stored in the setting storage unit 202 when the CPU usage ratio or the time spent to collect traffic data exceeds the second threshold.

Some embodiments of the present invention have been described above. However, the specific configuration is not limited to the foregoing.

For example, although the above embodiments have described the case where the traffic data collection apparatus is integrated into the LTE system, the configuration is not limited and the traffic data collection apparatus may be integrated into other communication systems.

(Basic Configuration)

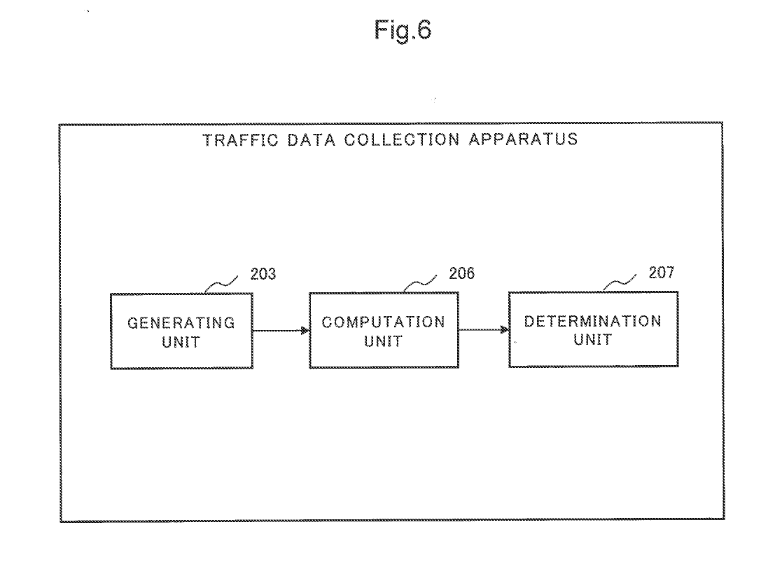

FIG. 6 is a schematic block diagram showing a basic configuration of a traffic data collection apparatus according to the present invention.

While the above embodiments have described the maintenance server 200 shown in FIGS. 1 and 4 as an embodiment of the traffic data collection apparatus according to the present invention, the basic configuration of the traffic data collection apparatus according to the present invention is as shown in FIG. 6.

In other words, the basic configuration of the traffic data collection apparatus according to the present invention includes a generating unit 203, a computation unit 206, and a determination unit 207.

The generating unit 203 generates traffic data that is information on traffic processed by a device under management.

The computation unit 206 calculates the amount of computational resources spent by the generating unit 203 to generate traffic data during a predetermined collection GP.

The determination unit 207 determines that traffic data is excessive when the amount of computational resources calculated by the computation unit 206 exceeds a predetermined threshold.

The traffic data collection apparatus can thus determine whether traffic data is excessive, in accordance with the volume of the traffic data.

The foregoing maintenance server 200 includes a computer system. The operation of the foregoing processing units is stored in a computer-readable recording medium in a program format and a computer reads and executes the program to perform the processing described above.

The computer-readable recording medium refers to a magnetic disk, a magneto-optical disk, a compact disc read only memory (CD-ROM), a digital versatile disc read only memory (DVD-ROM), a semiconductor memory, or the like. The computer program may be delivered to computers via communication lines so that the destination computers can execute the program.

The computer program may also be used to enable a part of the functions described above.

Additionally, the computer program may be what is called a differential file (differential program), which enables the functions in combination with a program already recorded in the computer system.

The whole or part of the exemplary embodiments disclosed above can be described as, but not limited to, the following supplementary notes.

(Supplementary Note 1)

A traffic data collection apparatus including:

a generating unit configured to generate traffic data that is information on traffic processed by a device under management;

a computation unit configured to calculate an amount of computational resources spent by the generating unit to generate traffic data during a predetermined collection granularity period; and

a determination unit configured to determine that traffic data is excessive when the amount of computational resources calculated by the computation unit exceeds a predetermined threshold.

(Supplementary Note 2)

The traffic data collection apparatus according to Supplementary Note 1, further including:

a setting storage unit configured to store categories of elements that constitute the traffic data; and

a deletion unit configured to delete one or more categories stored in the setting storage unit when the determination unit determines that traffic data is excessive, in which

the generating unit generates, out of information on traffic processed by the device under management, traffic data consisting of elements the categories of which are stored in the setting storage unit.

### Supplementary Note 3

The traffic data collection apparatus according to Supplementary Note 2, in which

the deletion unit receives, from an administrator, input of a category that needs to be omitted from the traffic data and deletes the category from the setting storage unit.

(Supplementary Note 4)

The traffic data collection apparatus according to Supplementary Note 2, in which

the setting storage unit stores priorities in association with the respective categories, and

the deletion unit deletes a category of the lowest priority of the categories stored in the setting storage unit when the determination unit determines that traffic data is excessive.

(Supplementary Note 5)

The traffic data collection apparatus according to any one of Supplementary Notes 1 to 3, further including:

a warning unit configured to issue a warning when the determination unit determines that traffic data is excessive.

(Supplementary Note 6)

The traffic data collection apparatus according to any one of Supplementary Notes 1 to 5, in which

the computation unit calculates the volume of traffic data generated by the generating unit during the predetermined collection granularity period as the amount of computational resources.

(Supplementary Note 7)

The traffic data collection apparatus according to any one of Supplementary Notes 1 to 5, in which

the computation unit calculates the CPU usage ratio when the generating unit generates traffic data during the predetermined collection granularity period as the amount of computational resources.

(Supplementary Note 8)

The traffic data collection apparatus according to any one of Supplementary Notes 1 to 5, in which

the computation unit calculates a time spent by the generating unit to collect traffic data as the amount of computational resources.

(Supplementary Note 9)

A traffic data collection method including:

a generation step of generating traffic data that is information on traffic processed by a device under management;

a recording step of recording the generated traffic data in a data storage unit;

a calculation step of calculating the volume of traffic data stored in the data storage unit; and

a determination step of determining that traffic data is excessive when the calculated volume of data exceeds a predetermined threshold.

(Supplementary Note 10)

The traffic data collection method according to Supplementary Note 9, in which

the generation step generates, out of information on traffic processed by the device under management, traffic data consisting of elements the categories of which are stored in a setting storage unit configured to store categories of elements that constitute traffic data, and

a deletion step is included that deletes one or more categories stored in the setting storage unit when the determination step determines that traffic data is excessive.

(Supplementary Note 11)

A computer program that causes a computer to serve as:

a generating unit configured to generate traffic data that is information on traffic processed by a device under management;

a recording unit configured to record the traffic data generated by the generating unit in a data storage unit;

a computation unit configured to calculate the volume of traffic data stored in the data storage unit; and

a determination unit configured to determine that traffic data is excessive when the volume of data calculated by the computation unit exceeds a predetermined threshold.

(Supplementary Note 12)

The computer program according to Supplementary Note 11, in which

the computer is further caused to serve as a deletion unit configured to delete one or more categories stored in a setting storage unit configured to store categories of elements that constitute the traffic data when the determination unit determines that traffic data is excessive, and

the generating unit generates, out of information on traffic processed by the device under management, traffic data consisting of elements the categories of which are stored in the setting storage unit.

This application is based upon and claims the benefit of priority from Japanese patent application No. 2012-172381, filed on Aug. 2, 2012, the disclosure of which is incorporated herein in its entirety by reference.

### INDUSTRIAL APPLICABILITY

The present invention enables determination as to whether traffic data is excessive in accordance with the volume of the traffic data.

### REFERENCE SIGNS LIST

100 . . . wireless base station
200 . . . maintenance server
201 . . . setting unit
202 . . . setting storage unit
203 . . . generating unit
204 . . . data storage unit
205 . . . recording unit
206 . . . computation unit
207 . . . determination unit
208 . . . warning unit
209 . . . deletion unit
300 . . . maintenance client

1. A traffic data collection apparatus comprising:
a generating unit configured to generate traffic data that is information on traffic processed by a device under management;
a computation unit configured to calculate an amount of computational resources spent by the generating unit to generate traffic data during a predetermined collection granularity period; and
a determination unit configured to determine that traffic data is excessive when the amount of computational resources calculated by the computation unit exceeds a predetermined threshold.

2. The traffic data collection apparatus according to claim 1, further comprising:
a setting storage unit configured to store categories of elements that constitute the traffic data; and
a deletion unit configured to delete one or more categories stored in the setting storage unit when the determination unit determines that traffic data is excessive, wherein
the generating unit generates, out of information on traffic processed by the device under management, traffic data consisting of elements the categories of which are stored in the setting storage unit.

3. The traffic data collection apparatus according to claim 2, wherein
the deletion unit receives, from an administrator, input of a category that needs to be omitted from the traffic data and deletes the category from the setting storage unit.

4. The traffic data collection apparatus according to claim 2, wherein
the setting storage unit stores priorities in association with the respective categories, and
the deletion unit deletes a category of the lowest priority of the categories stored in the setting storage unit when the determination unit determines that traffic data is excessive.

5. The traffic data collection apparatus according to claim 1, further comprising:
a warning unit configured to issue a warning when the determination unit determines that traffic data is excessive.

6. The traffic data collection apparatus according to claim 1, wherein
the computation unit calculates a volume of traffic data generated by the generating unit during the predetermined collection granularity period as the amount of computational resources.

7. A traffic data collection method comprising the steps of:
generating traffic data that is information on traffic processed by a device under management;
recording the generated traffic data in a data storage unit;
calculating a volume of traffic data stored in the data storage unit; and
determining that traffic data is excessive when the calculated volume of data exceeds a predetermined threshold.

8. The traffic data collection method according to claim 7, wherein
out of information on traffic processed by the device under management, the traffic data consists of elements categories of which are stored in a setting storage unit configured to store categories of elements that constitute traffic data, and
the traffic data collection method further comprises:
deleting one or more categories stored in the setting storage unit when the determination step determines that traffic data is excessive.

9. A non-transitory computer-readable recording medium for storing a program that causes a computer to function as:
a generating unit configured to generate traffic data that is information on traffic processed by a device under management;
a recording unit configured to record the traffic data generated by the generating unit in a data storage unit;
a computation unit configured to calculate a volume of traffic data stored in the data storage unit; and
a determination unit configured to determine that traffic data is excessive when the volume of data calculated by the computation unit exceeds a predetermined threshold.

10. The recording medium for storing the program according to claim 9, wherein
the computer is further caused to serve as a deletion unit configured to delete one or more categories stored in a setting storage unit configured to store categories of elements that constitute the traffic data when the determination unit determines that traffic data is excessive, and
the generating unit generates, out of information on traffic processed by the device under management, traffic data consisting of elements the categories of which are stored in the setting storage unit.

11. The traffic data collection apparatus according to claim 2, further comprising:
a warning unit configured to issue a warning when the determination unit determines that traffic data is excessive.

12. The traffic data collection apparatus according to claim 3, further comprising:
a warning unit configured to issue a warning when the determination unit determines that traffic data is excessive

13. The traffic data collection apparatus according to claim 2, wherein
the computation unit calculates a volume of traffic data generated by the generating unit during the predetermined collection granularity period as the amount of computational resources.

14. The traffic data collection apparatus according to claim 3, wherein
the computation unit calculates a volume of traffic data generated by the generating unit during the predetermined collection granularity period as the amount of computational resources.

15. The traffic data collection apparatus according to claim 4, wherein
the computation unit calculates a volume of traffic data generated by the generating unit during the predetermined collection granularity period as the amount of computational resources.

16. The traffic data collection apparatus according to claim 5, wherein
the computation unit calculates a volume of traffic data generated by the generating unit during the predetermined collection granularity period as the amount of computational resources.

17. The traffic data collection apparatus according to claim 11, wherein
the computation unit calculates a volume of traffic data generated by the generating unit during the predetermined collection granularity period as the amount of computational resources.

18. The traffic data collection apparatus according to claim 12, wherein
the computation unit calculates a volume of traffic data generated by the generating unit during the predetermined collection granularity period as the amount of computational resources.
